(19) United States
(12) Patent Application Publication
(10) Pub. No.: US 2016/0219235 A1
(43) Pub. Date: Jul. 28, 2016

(54) SOLID-STATE IMAGE PICKUP DEVICE

(71) Applicant: Kabushiki Kaisha Toshiba, Minato-ku (JP)

(72) Inventor: Kazunori KAKEHI, Oita (JP)

(73) Assignee: Kabushiki Kaisha Toshiba, Minato-ku (JP)

(21) Appl. No.: 14/972,781

(22) Filed: Dec. 17, 2015

(30) Foreign Application Priority Data
Jan. 26, 2015 (JP) 2015-012606

(51) Int. Cl. H04N 5/378; G02B 3/00; H04N 5/232; G02B 5/20; H04N 5/345; H04N 5/3745

(52) U.S. Cl. CPC H04N 5/378; H04N 5/3454; H04N 5/37455; H04N 5/23293; G02B 5/201; G02B 3/0056

(57) ABSTRACT

A solid-state image pickup device according to an aspect of an embodiment includes a plurality of photoelectric conversion elements, a first color filter, and a second color filter. The plurality of the photoelectric conversion elements are arranged in two dimensions. The first color filter is provided over a light receiving surface of the photoelectric conversion element and selectively transmits light other than long-wavelength light in visible light. The second color filter is provided over a light receiving surface of the photoelectric conversion element other than the photoelectric conversion element provided with the first color filter, is greater in area than the first color filter, and selectively transmits the long-wavelength light in visible light.

### CROSS-REFERENCE TO RELATED APPLICATIONS

This application is based upon and claims the benefit of priority from Japanese Patent Application No. 2015-012606, filed on Jan. 26, 2015; the entire content of which are incorporated herein by reference.

### FIELD

The embodiment described herein relates generally to a solid-state image pickup device.

### BACKGROUND

Conventionally, a solid-state image pickup device includes a plurality of photoelectric conversion elements arranged in two dimensions. Over a light receiving surface of each of the photoelectric conversion elements, a color filter selectively transmitting short-wavelength light such as blue light, a color filter selectively transmitting medium-wavelength light such as green light, and a color filter selectively transmitting long-wavelength light such as red light are provided.

On each of the color filters, a micro lens concentrating incident light on the corresponding photoelectric conversion element is provided. As to the solid-state image pickup device, it is common that, in accord with the areas of the light receiving surfaces of the photoelectric conversion elements having the same size, the color filters have all the same area.

For the recent years, such solid-state image pickup devices have tended to progress to downsizing, and accordingly, the photoelectric conversion elements and the color filters have also been progressing to miniaturization. In the solid-state image pickup devices, however, when the color filters are miniaturized, it is hard for the long-wavelength light in visible light to reach the photoelectric conversion elements. Thus, the solid-state image pickup devices, in association with the downsizing, possibly degrade image quality of picked-up images.

### BRIEF DESCRIPTION OF THE DRAWINGS

FIG. 1 is a schematic block diagram illustrating a configuration of a digital camera including a solid-state image pickup device according to an embodiment;

FIG. 2 is a schematic block diagram illustrating a configuration of the solid-state image pickup device according to the embodiment;

FIG. 3 is an explanatory diagram illustrating a part of pixel arrays that are contrasted with a pixel array according to the embodiment;

FIG. 4 is an explanatory diagram illustrating a part of color filters in the pixel array according to the embodiment;

FIG. 5 an explanatory diagram illustrating a part of the pixel array cording to the embodiment;

FIG. 6 is an explanatory diagram illustrating a part of a pixel array according to Modification Example 1 of the embodiment;

FIG. 7 is an explanatory diagram illustrating a part of a pixel array according to Modification Example 2 of the embodiment;

FIG. 8 is an explanatory diagram illustrating a part of a pixel array according to Modification Example 3 of the embodiment;

FIG. 9 is an explanatory diagram illustrating a part of a pixel array according to Modification Example 4 of the embodiment;

FIG. 10 is an explanatory diagram illustrating a part of a pixel array according to Modification Example 5 of the embodiment; and

FIG. 11 is an explanatory diagram illustrating part of a pixel array according to Modification Example 6 of the embodiment.

### DETAILED DESCRIPTION

According to one embodiment, a solid-state image pickup device is provided. The solid-state image pickup device according to one aspect of the embodiment includes a plurality of photoelectric conversion elements, first color filters, and second color filters. The plurality of the photoelectric conversion elements are arranged in two dimensions. The first color filters are arranged over light receiving surfaces of the photoelectric conversion elements to selectively transmit light other than long-wavelength light in visible light. The second color filters are arranged over light receiving surfaces of the photoelectric conversion elements other than the photoelectric conversion elements provided with the first color filters and are greater in area than the first color filters to selectively transmit the long-wavelength light in visible light.

Hereinafter, with reference to the accompanying drawings, the solid-state image pickup device according to the embodiment will be described in detail. It is not intended the present invention is limited by such an embodiment.

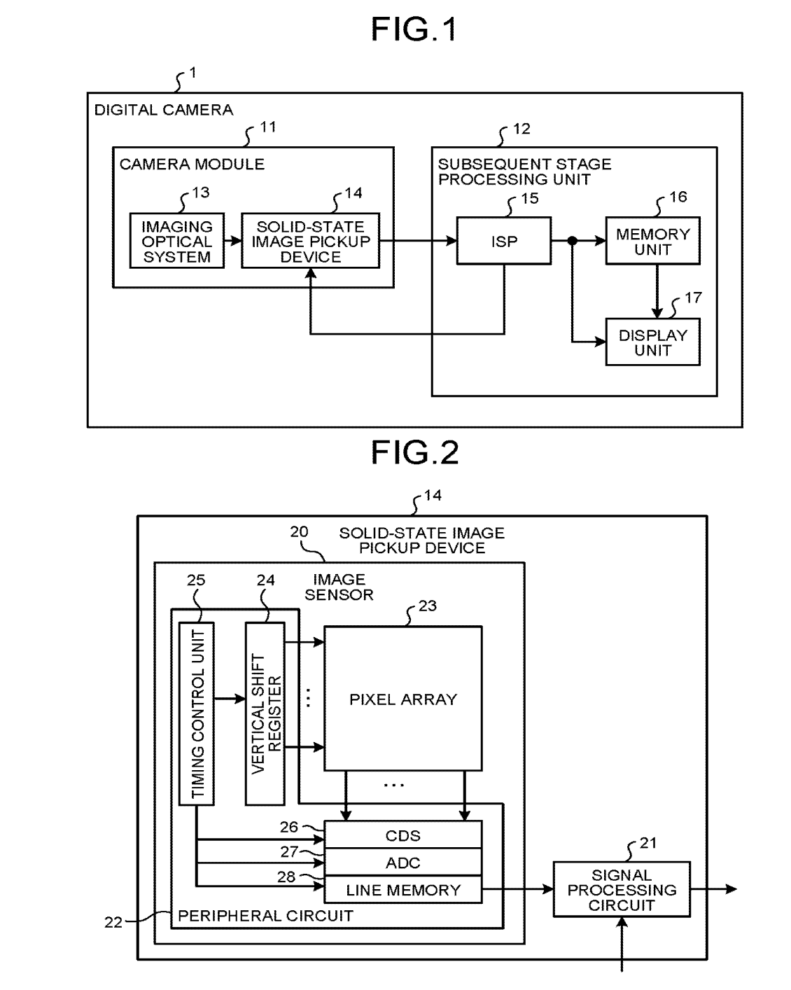

FIG. 1 is a schematic block diagram illustrating a configuration of a digital camera 1 that includes a solid-state image pickup device 14 according to the embodiment. As illustrated in FIG. 1, the digital camera 1 includes a camera module 11 and a subsequent stage processing unit 12.

The camera module 11 includes an imaging optical system 13 and the solid-state image pickup device 14. The imaging optical system 13 takes light in from an object and form an image of the object. The solid-state image pickup device 14 picks up the object image formed by the imaging optical system 13 and then outputs an image signal acquired by the image formation to the subsequent stage processing unit 12. Such a camera module 11 is applied, for example, to electric instruments like a portable terminal with a camera and the like, other than the digital camera 1.

The subsequent stage processing unit 12 includes an ISP (Image Signal Processor) 15, a memory unit 16, and a display unit 17. The ISP 15 performs processing of the image signal input from the solid-state image pickup device 14. Such an ISP 15 performs, for example, image quality enhancing processes such as a noise removal process, a defective image correcting process, a resolution converting process, and the like.

Then, the ISP 15 outputs the processed image signal to the memory unit, the display unit 17, and a signal processing circuit 21 (see FIG. 2) incorporated in the solid-state image pickup device 14 in the camera module 11. The image signal fed back from the ISP 15 to the camera module 11 is used for adjustment and control of the solid-state image pickup device 14.

The memory unit 16 stores the image signal input from the ISP 15 as an image. Also, the memory unit 16 outputs the image signal of the image to the display unit 17 according to user's operations. The display unit 17 displays the image in accordance with the image signal input from the ISP 15 or the memory unit 16. Such a display unit 17 is, for example, a liquid crystal display.

With reference to FIG. 2, the solid-state image pickup device 14 incorporated in the camera module 11 will now be described. FIG. 2 is a schematic block diagram illustrating a configuration of the solid-state image pickup device 14 according to the embodiment. As illustrated in FIG. 2, the solid-state image pickup device 14 includes an image sensor 20 and the signal processing circuit 21.

In the following, explained is a case that the image sensor 20 is the so-called back side illumination type CMOS (Complementary Metal Oxide Semiconductor) image sensor where a wiring layer is formed in a side reverse to the surface on which light incident on the photoelectric conversion elements and photoelectrically converted by the same falls. The image sensor 20 according to the embodiment is not limited to such a back side illumination type CMOS image sensor and instead may be a front side irradiated CMOS image sensor.

The image sensor 20 includes a peripheral circuit 22 composed primarily of analog circuits, and a pixel array 23. Also, the peripheral circuit 22 includes a vertical shift register 24, a timing control unit 25, a CDS (correlative dual sampling) unit 26, an ADC (analog-digital converting) unit 27, and a line memory 28.

The pixel array 23 is provided in an image pickup region of the image sensor 20. In such a pixel array 23, a plurality of photoelectric conversion elements, each corresponding to each of pixels for a picked-up image, are arranged in two-dimensional arrays (in matrix) in the horizontal direction (row-wise direction) and in the vertical direction (column-wise direction).

Over a light receiving surface of each of the photoelectric conversion elements, a color filter is provided, which selectively transmits short-wavelength light such as blue light, medium-wavelength light such as green light, or long-wavelength light such as red light. In addition, over each of the color filters, a micro lens concentrating the incident light on the photoelectric conversion element is provided.

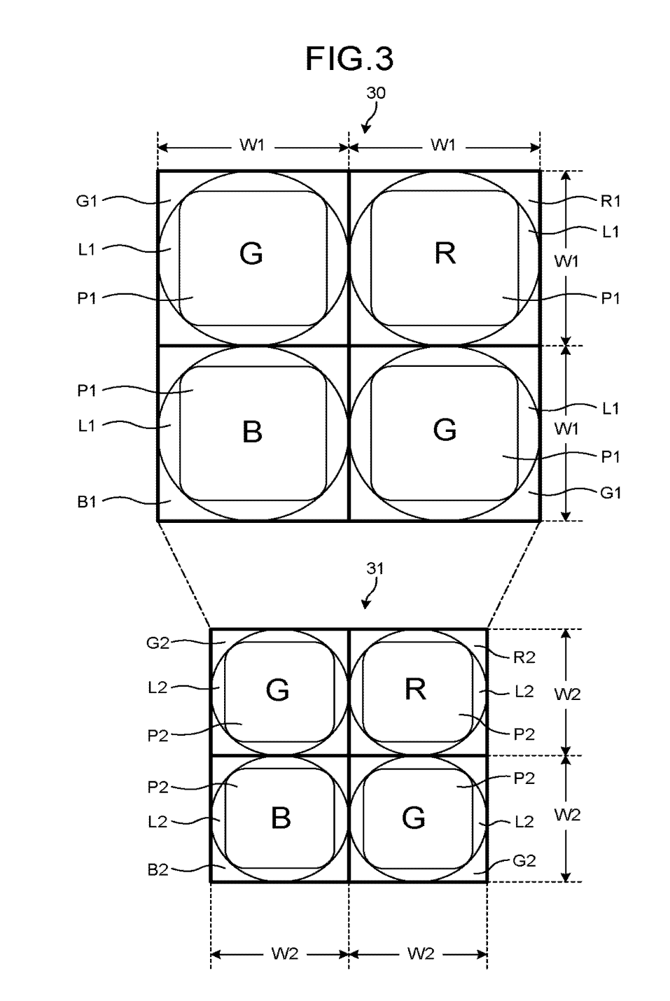

In the pixel array 23 according to the embodiment, second color filters selectively transmitting the long-wavelength light are greater in area than first color filters selectively transmitting the short- and medium-wavelength lights other than the long-wavelength light. In this manner, the pixel array 23 can suppress the degradation of image quality in association with the downsizing. A configuration of such a pixel array 23 will be specifically explained with reference to FIG. 3 and the succeeding drawings.

The photoelectric conversion elements are photodiodes, for example, each being formed by a PN-junction of a P-type semiconductor region of a first conductivity type and an N-type semiconductor region of a second conductivity type, which generate signal charges (e.g., electrons) in accordance with quantity of the incident light and accumulate them.

In the event that a predetermined voltage is applied to a transfer gate provided in each of the photoelectric conversion elements, the signal charge accumulated in the photoelectric conversion element is transferred through a charge transfer region to a floating diffusion and stored therein.

The timing control unit 5 is connected to the vertical shift register 24, the CDS 26, the ADC 27, and the line memory 28 to control operation timings of the vertical shift register 24, the CDS 26, the ADC 27, and the line memory 28.

The vertical shift register 24 is a processing unit that outputs to the pixel array 23 selection signals for sequentially selecting in units of a row, among the plurality of the photoelectric conversion elements arranged in arrays (rows and columns) in two dimensions, the photoelectric conversion elements from which the signal charges are to be read out.

The pixel array 23 outputs the signal charge accumulated in each of the photoelectric conversion elements selected in units of a row of them according to the selection signals input from the vertical shift register 24, as a pixel signal indicating luminance of each of the pixels from the photoelectric conversion elements to the CDS 26.

The CDS 26 is a processing unit that removes noise from the pixel signals input from the pixel array 23 by correlative dual sampling and outputs the result to the ADC 27. The ADC 27 is a processing unit that converts the analog pixel signals input from the CDS 26 to digital pixel signals and outputs the result to the line memory 28. The line memory 28 is a processing unit that temporarily stores the pixel signals input from the ADC 27 and outputs pixel signals for photoelectric conversion elements in each row to the signal processing circuit 21.

The signal processing circuit 21 is a processing unit that is composed primarily of digital circuits, and performs a predetermined signal processing on the pixel signals input from the line memory 28 and outputs the processed pixel signals as an image signal to the subsequent stage processing unit 12. The signal processing circuit 21 performs signal processes such as a lens shading correcting process, a scratch correcting process, a noise reducing process, and the like, for example.

Thus, in the image sensor 20, the plurality of the photoelectric conversion elements arranged in the pixel array 23 photoelectrically convert the incident light to signal charges in accordance with quantity of the received light and accumulate them, and the peripheral circuit 22 reads out the signal charges accumulated in the photoelectric conversion elements as the pixel signals so as to pick up an image.

Next, the pixel array 23 according to the embodiment will be specifically explained. In the following, configurations of other pixel arrays contrasted with the pixel array 23 will first be explained, and thereafter, a configuration of the pixel array 23 according to the embodiment will be described. FIG. 3 is an explanatory diagram illustrating a part of pixel arrays 30, 31 that are contrasted with the pixel array 23 according to the embodiment.

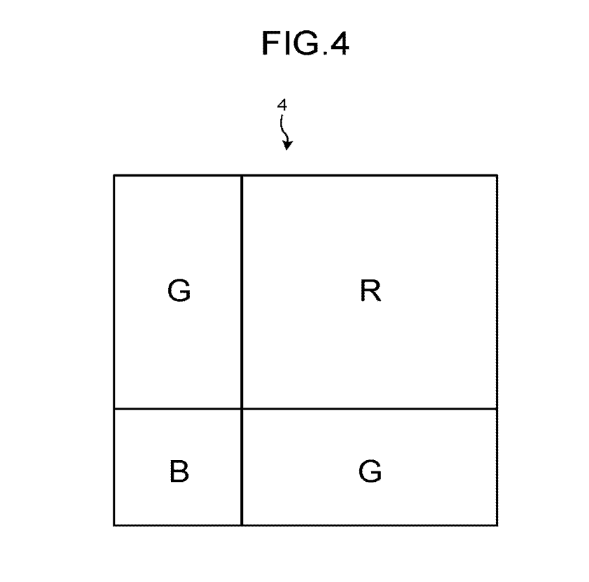

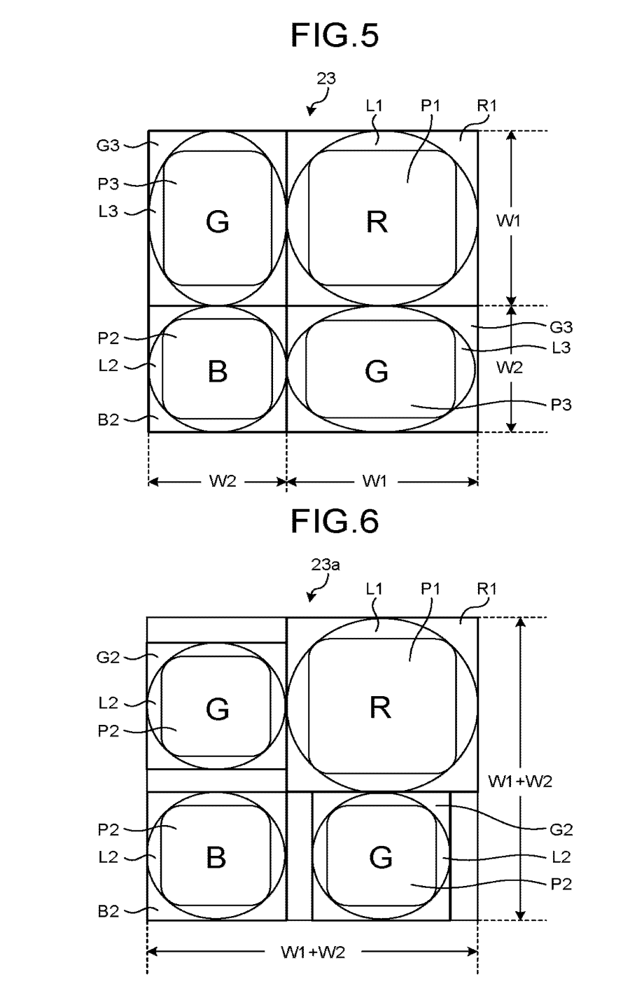

FIG. 4 is an explanatory diagram illustrating a part of the color filters 4 in the pixel array 23 according to the embodiment, and FIG. 5 is an explanatory diagram illustrating a part of the pixel array 23 according to the embodiment.

In FIG. 3 to FIG. 5, the photoelectric conversion elements are illustrated by rectangles with rounded corners, the color filters by squares and/or oblongs, and the micro lenses by circles and/or ellipses. The components of the same shape and size in those illustrated in FIG. 3 to FIG. 5 are denoted by the same reference symbols.

Although, in the following, explained will be a case that the short-wavelength light in visible light is blue light, the medium-wavelength light is green light, and the long-wavelength light is red light, the short-, medium-, and long-wavelength lights according to the embodiment are not limited to it.

For example, they may be of any other colors if any with wavelengths included in three roughly divided visible light frequency bands, short-, medium-, and long-wavelength ranges, as in the case where the short-wavelength light is cyan, the medium-wavelength light is yellow, and the long-wavelength light is magenta.

Also, letters of R, G, and B denoted by boldface in FIG. 3 to FIG. 5 indicate that the lights selectively transmitted through the corresponding color filters are red light (Red), green light (Green), and blue light (Blue), respectively.

As illustrated in an upper section of FIG. 3, in the common pixel array 30, a plurality of photoelectric conversion elements P1 of the same shape are arranged in columns and rows in two dimensions. Although a part of the pixel array 30 with four photoelectric conversion elements is illustrated in the drawing, the pixel array 30 is generally provided with several millions photoelectric conversion elements P1 arranged in rows and columns.

Over light receiving surfaces of the photoelectric conversion elements P1, color filters R1, G1, and B1 of the same size and shape (square in this case) are provided. The color filter R1 selectively transmits red light. The color filters G1 selectively transmit green light. The color filter B1 selectively transmits blue light. Hereinafter, the color filter selectively transmitting red light is referred to as red filter, the color filters selectively transmitting green light as green filter, and the color filter selectively transmitting blue light as blue filter.

As to the arrangement of the color filters, as illustrated in FIG. 3, widely known is a Bayer arrangement in which columns of the alternate green and blue filters G1 and B1 in the column-wise direction and columns of the alternate red and green filters R1 and G1 in the column-wise direction are arranged alternately in the row-wise direction. In such a Bayer arrangement, rows of the alternate green and red filters G1 and R1 in the row-wise direction and rows of the alternate blue and green filters B1 and G1 in the row-wise direction are arranged alternately in the column-wise direction.

On the red filter R1, the green filters G1, and the blue filter B1, micro lenses L1 of the same size and shape (circle in this case) are provided. It is now assumed that the red filter R1, the green filters G1, and the blue filter B1 in the pixel array 30 have the dimensions (e.g., the length of a side) of length W1 greater than the wavelength of red light. With such a pixel array 30, each of the photoelectric conversion elements P1 can receive a sufficient quantity of the incident light to photoelectrically convert it.

Meanwhile, the pixel array 31 illustrated in a lower section of FIG. 3 includes photoelectric conversion elements P2, a red filter R2, green filters G2, a blue filter B2, and the micro lenses L2, which are all smaller in size than those in the pixel array 30 illustrated in the upper section. In this manner, the pixel array 31 illustrated in the lower section of FIG. 3 can be downsized more than the pixel array 30 in the upper section.

When the red filter R2, the green filters G2, and the blue filter B2 in the pixel array 31 are downsized to the dimensions (e.g., the length of a side) of length W2 greater than the wavelength of blue light and equal to or smaller than the wavelength of red light, however, the red light transmitted through the red filter R2 diffracts.

This makes it hard in the pixel array 31 for the red light to reach the photoelectric conversion elements P2 provided with the red filters R2 over their respective light receiving surfaces, and image quality of the picked-up image is degraded because quantity of the red light received by the photoelectric conversion elements P2 is reduced.

In view of this, the color filters according to the embodiment include first color filters selectively transmitting light other than the long-wavelength light in visible light and second color filters greater in area than the first color filters and selectively transmitting the long-wavelength light in the visible light. The first color filters include third color filters selectively transmitting the short-wavelength light in the visible light and fourth color filters selectively transmitting the medium-wavelength light in the visible light.

Specifically, as illustrated in FIG. 4, each of the color filters 4 according to the embodiment include a red filter (an example of the second color filters) that is of dimensions greater than the wavelength of red light and is greater in area than a blue filter (an example of the third color filters) and green filters (an example of the fourth color filters).

In this manner, even when the downsizing of the solid-state image pickup device 14 leads to the reduction of the areas of the green and blue filters, the color filters 4 can suppress the reduction of quantity of the received red light because the dimensions of the red filter is greater than the wavelength of the red light.

The pixel array 23 including such color filters 4 has, for example, as illustrated in FIG. 5, a square red filter R1 with a side of the length W1 and a square blue filter B2 with a side of the length W2 arranged without overlapping in position where diagonals of both the squares are aligned.

In this embodiment, a square of which diagonal is identical with a segment connecting the opposite ends of the aligned diagonals of the red and blue filters R1 and B2 is prescribed, and a green filter(s) G3 is arranged in a region where the red and blue filters R1 and B2 are not arranged in the prescribed square. This defines the green filter G3 in a rectangle with a longer side of the length W1 and a shorter side of the length W2.

The micro lenses L1 over the red filters R1 are the same with the micro lenses L1 illustrated in the upper section of FIG. 3. Also, the photoelectric conversion elements P1 provided with the red filters R1 over their respective light receiving surfaces are the same as the photoelectric conversion elements P1 illustrated in the upper section of FIG. 3, and are shaped in rectangles with rounded corners that are inscribed in the micro lenses L1 in a plan view.

The micro lens L1 is not necessarily inscribed in the red filter R1 in the plan view but may be larger or smaller than that illustrated in FIG. 5. When it is larger than that illustrated in FIG. 5, the micro lens L1 has the arc-like four corners in the plan view and has the straight-line left, right, top and bottom sides that are overlapped with the boundaries between the red filter R1 and the other color filters adjacent to the red filter R1.

The photoelectric conversion element P1 is not necessarily inscribed in the micro lens L1 in the plan view, but may be larger or smaller than those illustrated in FIG. 5 if it is smaller than the red filter R1 in the plan view.

The micro lens L2 provided on the blue filter B2 is the same as the micro lenses L2 illustrated in the lower section of FIG. 3. The photoelectric conversion element P2 provided with the blue filter B2 over its light receiving surface is the same as the photoelectric conversion elements P2 illustrated in the lower section of FIG. 3 and are shaped in rectangles with rounded corners that are inscribed in the micro lens L2 in the plan view.

Meanwhile, the micro lens L2 may be greater or smaller than that illustrated in FIG. 5. When it is greater than that illustrated in FIG. 5, the micro lens L2 has the arc-like four corners in the plan view and has the straight-line left, right, top and bottom sides that are overlapped with the boundaries between the blue filter B2 and the other color filters adjacent to the blue filter B2. The photoelectric conversion element P2 may be larger or smaller than that illustrated in FIG. 5 if it is smaller than the blue filter B2 in the plan view.

Micro lenses L3 provided over the green filters G3 are shaped in ellipses with a longer diameter of the length W1 and a shorter diameter of the length W2 in the plan view. Also, the photoelectric conversion elements P3 provided with the green filters G3 over their respective light receiving surfaces are shaped in rectangles with rounded corners that are inscribed in the micro lenses L3 in the plan view.

The micro lenses L3 may be greater or smaller than those illustrated in FIG. 5. When they are greater than those illustrated in FIG. 5, each of the micro lenses L3 has the arc-like four corners in the plan view and has the straight-line left, right, top and bottom sides that are overlapped with the boundaries between the corresponding green filter G3 and the other color filters adjacent to the green filter G3. Also, the photoelectric conversion elements P3 may be larger or smaller than those illustrated in FIG. 5 if they are smaller than the green filters G3 in the plan view.

With such a pixel array 23, a side of a region where two green filters G3, one blue filter B2, and one red filter R1 are arranged is of length W1+W2 shorter than the side of length W1+W1 of the square illustrated in FIG. 3, and thus, the pixel array can be downsized.

Moreover, a side of the red filter R1 is of the length W1 greater than the wavelength of red light. Hence, with the pixel array 23, the reduction of quantity of the red light received by the photoelectric conversion element P1 can be suppressed by suppressing the diffraction of the red light transmitted through the red filters R1, and therefore, the degradation of the picked-up image due to the downsizing can be suppressed.

Furthermore, the green filters G3 have a longer side greater than the wavelength of red light, and hence, even when green light with the wavelength shorter than that of red light is transmitted therethrough, the diffraction of the transmitted light can be prevented. Thus, the green filters G3 can transmit a sufficient quantity of the green light to the photoelectric conversion elements P3 although smaller in area than the green filters G1 illustrated in FIG. 3. The blue filters B2 have a side of the length W2 greater than the wavelength of blue light. Hence, the blue filters B2 can transmit a sufficient quantity of the blue light to the photoelectric conversion elements P2.

In this manner, the pixel array 23 can permit the red filters R1, the green filters G3, and the blue filters B2 to transmit a sufficient quantity of the incident light to their respective corresponding photoelectric conversion elements P1, P3, and P2, and therefore, can suppress the degradation of image quality of the picked-up image due to the downsizing.

In the aforementioned, a case that the red filters R1 have a side of the length W greater than the wavelength of red light has been explained, but simply by way of example. Even when the red filter R1 have a side of the length equal to or slightly shorter than the wavelength of red light, the pixel array 23 can suppress the degradation of image quality of the picked-up image due to the diffraction of the red light in comparison with the pixel array 31 illustrated in the lower section of FIG. 3.

Additionally, in the pixel array 23, the area of the micro lenses L1 provided over the red filters R1 is greater than the area of the micro lenses L2 provided over the blue filters B2. Moreover, in the pixel array 23, the area of the light receiving surfaces of the photoelectric conversion elements P1 over which the red filters R1 are provided is greater than the area of the light receiving surfaces of the photoelectric conversion elements P2 over which the blue filters B2 are provided. Thus, the pixel array 23 can suppress the degradation of image quality of the picked-up image by efficiently receiving the red light that is likely to reduce the quantity in association with the downsizing of the pixel array.

The pixel array 23 illustrated in FIG. 5 is given simply by way of example, and the configuration of the pixel array 23 according to the embodiment may be variously modified. Next, with reference to FIG. 6 to FIG. 11, pixel arrays 23a, 23b, 23c, 23d, 23e, and 23f according to Modified Examples 1 to 6 of the embodiment will be explained.

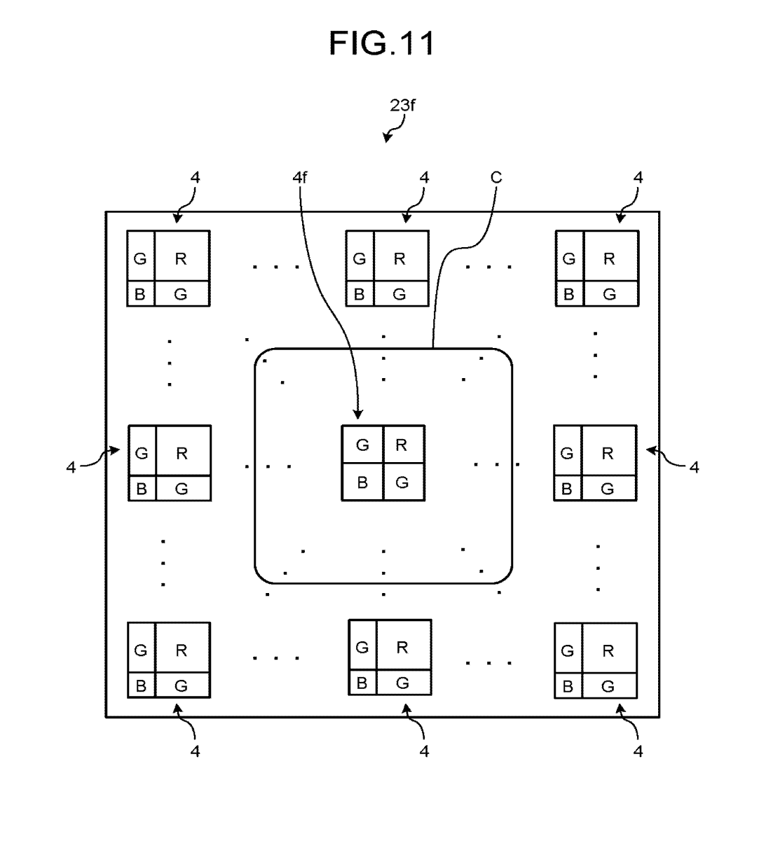

FIG. 6 to FIG. 10 are explanatory diagrams respectively illustrating a part of the pixel arrays 23a to 23e according to Modified Examples 1 to 5 of the embodiment, and FIG. 11 is an explanatory diagram illustrating the pixel array 23f according to Modified Example 6 of the embodiment.

The pixel array 23a according to Modified Example 1 has, as illustrated in FIG. 6, green filters G2, photoelectric conversion elements P2 provided with the green filters G2, and micro lenses L2 provided over the green filters G2 that are the same as those illustrated in the lower section of FIG. 3, and the remaining configuration is the same as that illustrated in FIG. 5.

Hence, the pixel array 23a can be downsized to the dimensions equivalent to those illustrated in FIG. 5, and because, similar to that illustrated in FIG. 5, the red filters R1 have the dimensions greater than the wavelength of red light, the pixel array 23a can suppress the degradation of image quality of the picked-up image in association with the downsizing.

In the pixel array 23a, compared with that illustrated in FIG. 5, the green filters G2 have the dimensions somewhat smaller, but this does not exert great adverse effects on image quality of the picked-up image because the green filters G2 are provided twice as many as either of the red filters R1 and the blue filters B2.

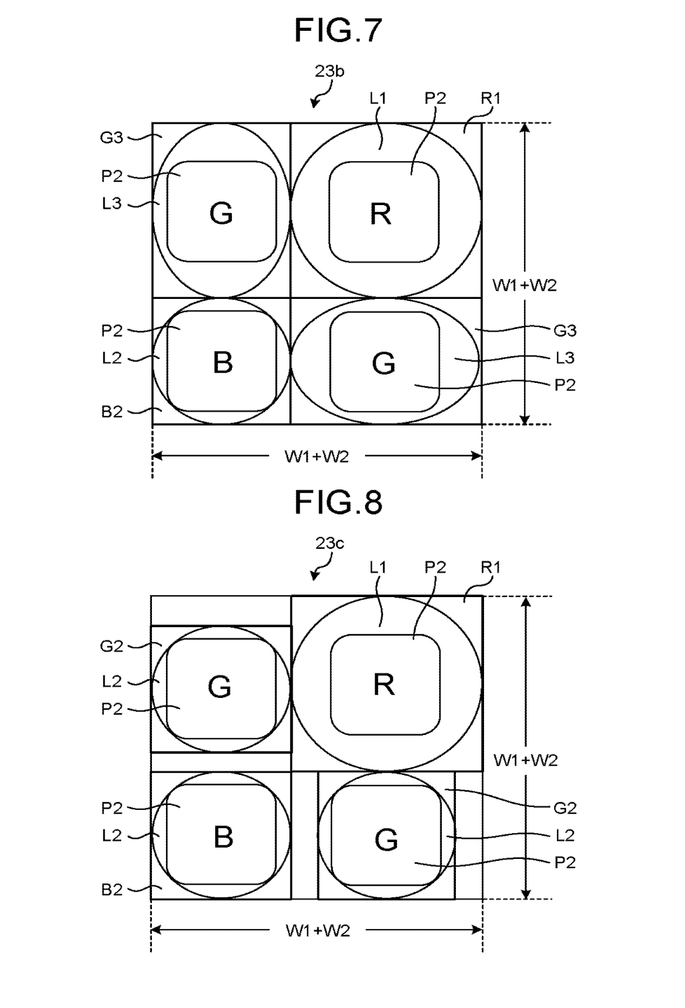

In a pixel array 23b according to Modified Example 2, as illustrated in FIG. 7, except that it has photoelectric conversion elements P2 that are all the same as the photoelectric conversion elements P2 illustrated in the lower section of FIG. 3, the remaining configuration is the same as that illustrated in FIG. 5.

Hence, the pixel array 23b can be downsized to the dimensions equivalent to those illustrated in FIG. 5, and can suppress the degradation of image quality of the picked-up image in association with the downsizing because the red filters R1 have the dimensions greater than the wavelength of red light similar to those illustrated in FIG. 5.

Also, in the pixel array 23b, the light receiving surfaces of the photoelectric conversion elements P2 over which the red filters R1 are provided are somewhat narrower than those of the photoelectric conversion elements P1 illustrated in FIG. 5, but the red filters R1 serving as frontages of the incident red light are of the same size as that of the red filters R1 illustrated in FIG. 5.

Hence, similar to the pixel array 23 illustrated in FIG. 5, the pixel array 23b can suppress the degradation of image quality of the picked-up image in association with the downsizing by suppressing the diffraction of the red light transmitted through the red filters R1. Also, in the pixel array 23b, all the photoelectric conversion elements P2 are of the same size and shape, and therefore, a mask pattern can be simplified, for example, in forming the photoelectric conversion elements P2 by using a mask on which planar shapes of the photoelectric conversion elements P2 are patterned.

The pixel array 23c according to Modified Example 3 has, as illustrated in FIG. 8, green filters G2, photoelectric conversion elements P2 provided with the green filters G2, and micro lenses L2 provided over the green filters G2 that are the same as those illustrated in the lower section of FIG. 3, and the remaining configuration is the same as that illustrated in FIG. 7.

Hence, the pixel array 23c can be downsized to the dimensions equivalent to those illustrated in FIG. 7, and can suppress the degradation of image quality of the picked-up image in association with the downsizing because red filters R1 have the dimensions greater than the wavelength of red light similar to that illustrated in FIG. 7.

Moreover, in the pixel array 23c, all the photoelectric conversion elements P2 are of the same size and shape, and hence, similar to that illustrated in FIG. 7, a mask pattern used to form the photoelectric conversion elements P2 can be simplified.

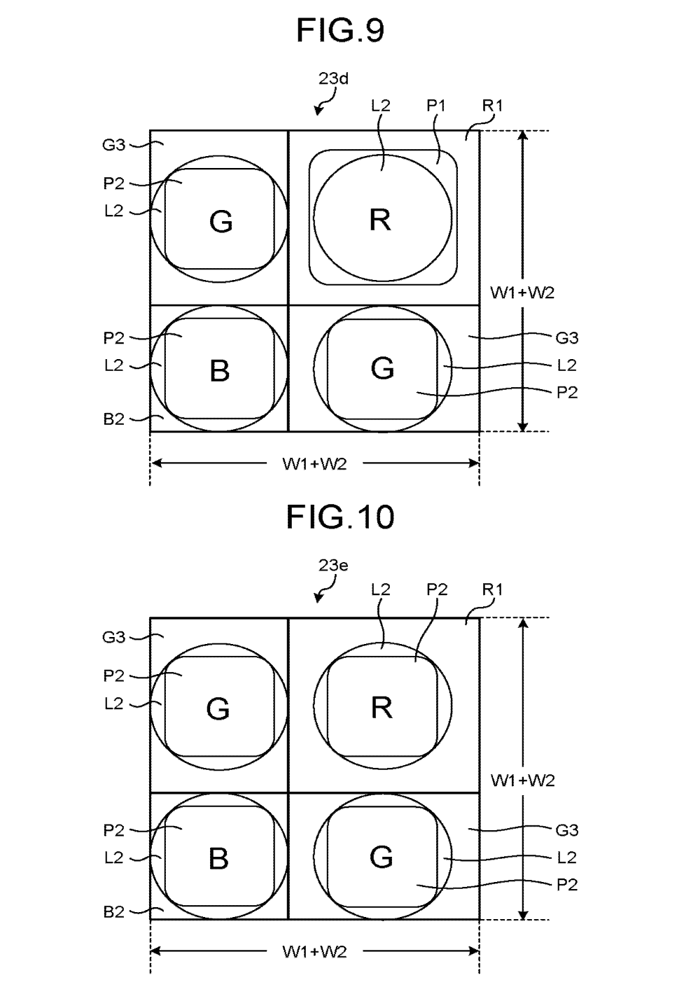

In a pixel array 23d according to Modified Example 4, as illustrated in FIG. 9, micro lenses L2 are all the same as the micro lenses L2 illustrated in the lower section of FIG. 3, and photoelectric conversion elements P2 provided with green filters G3 are the same as the photoelectric conversion elements P2 illustrated in the lower section of FIG. 3. The remaining configuration is the same as that illustrated in FIG. 5.

Hence, the pixel array 25d can be downsized to the dimensions equivalent to those illustrated in FIG. 5, and can suppress the degradation of image quality of the picked-up image in association with the downsizing because red filters R1 have the dimensions greater than the wavelength of red light similar to that illustrated in FIG. 5.

Also, in the pixel array 23d, all the micro lenses L2 are of the same size and shape, and therefore, a mask pattern can be simplified, for example, in forming the micro lenses L2 by using a mask on which planar shapes of the micro lenses L2 are patterned.

In a pixel array 23e according to Modified Example 5, as illustrated in FIG. 10, except that it has photoelectric conversion elements P2 that are all the same as those illustrated in the lower section of FIG. 3, the remaining configuration is the same as that illustrated in FIG. 9. Hence, the pixel array 23e can be downsized to the dimensions equivalent to those illustrated in FIG. 9, and can suppress the deterioration of image quality of the picked-up image in association with the downsizing because red filters R1 have the dimensions greater than the wavelength of red light similar to that illustrated in FIG. 9.

Also, because the pixel array 23e has the micro lenses L2 that are all of the same size and shape and has the photoelectric conversion elements P2 that are all of the same size and shape, patterns of a mask used in forming the micro lenses L2 and a mask in forming the photoelectric conversion elements P2 can be simplified.

A pixel array 23f according to Modified Example 6 includes, as illustrated in FIG. 11, color filters 4f provided in a center region C and color filters 4 provided outside the center region C. The color filters 4 provided outside the center region C are the same as those illustrated in FIG. 4.

In other words, each of the color filters 4 includes green filters G3, a blue filter B2, and a red filter R1 greater in area than the green filters G3 and the blue filter B2. Photoelectric conversion element and micro lenses provided outside the center region C are adopted from any of those illustrated in FIG. 5 to FIG. 10.

In contrast, any of the color filters 4f provided in the center region C includes a red filter, green filters, and a blue filter that are all of the same shape and area. The length of the color filters 4f is the same as that of the color filters 4, for example, W1+W2.

In this way, the pixel array 23f has, in its outer edge the incident light falls on from oblique directions, the color filters 4 each provided with the red filter greater in area than the green and blue filters. Hence, however small-sized it is, the pixel array 23f can receive the light incident on its outer edge from oblique directions, and can suppress the degradation of image quality of the picked-up image in association with the downsizing.

As mentioned above, the solid-state image pickup device according to the embodiment include red filters greater in dimensions than the wavelength of red light and greater in area than blue and green filters over light receiving surfaces of photoelectric conversion element other than the photoelectric conversion elements provided with the blue filters and the photoelectric conversion elements provided with the green filters. In this way, solid-state image pickup device can suppress the degradation of image quality of the picked-up image in association with the downsizing.

In the above-mentioned embodiment, a case that the red filters, the green filters, and the blue filters are provided in a Bayer arrangement has been illustrated, but simply by way of example; and they may be in a stripe arrangement or a delta arrangement if the area of the red filters is greater than the areas of the green and blue filters.

Also, in the above-mentioned embodiment, a case that the color filters are of three colors of red, green, and blue has been illustrated, but they may be of four colors of red, green, blue, and white. In such a case, for example, a white filter transmitting white light may be replaced with either of the two green filters illustrated in each of FIG. 4 to FIG. 11. Configured in such a manner, the solid-state image pickup device can also suppress the degradation of image quality of the picked-up image in association with the downsizing of the solid-state image pickup device because the red filters have the dimensions greater than the wavelength of red light.

Further, in the above-mentioned embodiment, it has been stated that the length(s) of a side(s) of the color filters is recognized as the dimension(s) of the color filters, but the diagonal(s) may be taken as the dimension(s) of the color filters when the color filters are shaped in rectangles. The dimension(s) of the color filters may be recognized as their respective diameters when the color filters are shaped in circles. Additionally, the dimension(s) of the color filters may be recognized as a longer diameter or a shorter diameter when the color filters are shaped in ellipses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state image pickup device comprising:
a plurality of photoelectric conversion elements arranged in two dimensions;
a first color filter provided over a light receiving surface of the photoelectric conversion element and selectively transmitting light other than long-wavelength light in visible light; and
a second color filter provided over a light receiving surface of the photoelectric conversion element other than the photoelectric conversion element provided with the first color filter, being greater in area than the first color filter, and selectively transmitting the long-wavelength light in the visible light.

2. The solid-state image pickup device according to claim 1, wherein
the first color filter has a size equal to or smaller than a wavelength of the long-wavelength light, and
the second color filter has a size greater than the wavelength of the long-wavelength light.

3. The solid-state image pickup device according to claim 1, wherein
the light receiving surface of the photoelectric conversion element provided with the second color filter is greater in area than that of the photoelectric conversion element provided with the first color filter.

4. The solid-state image pickup device according to claim 1, wherein
the first color filter includes:
a third color filter selectively transmitting short-wavelength light in the visible light; and
a fourth color filter selectively transmitting medium-wavelength light in the visible light.

5. The solid-state image pickup device according to claim 4, wherein
the fourth color filter is greater in area than the third color filter.

6. The solid-state image pickup device according to claim 1, further comprising color filters selectively transmitting long-wavelength light and light other than the long-wavelength light in the visible light, wherein
the color filters include color filters provided in a center region of a pixel array in which the photoelectric conversion elements are arranged in two dimensions, among the color filters provided in the center region, the color filter selectively transmitting the long-wavelength light is equal in area to that of the color filter selectively transmitting the light other than the long-wavelength light, and
the first and second color filters are provided outside the center region of the pixel array.

7. The solid-state image pickup device according to claim 4, wherein
the second color filter, the third color filter, and the fourth color filter are provided in a Bayer arrangement.

8. The solid-state image pickup device according to claim 4, wherein
the second color filter is shaped in a square in a plan view,
the third color filter is shaped in a square in the plan view that has a side shorter than a side of the second color filter in the plan view,
the second and third color filters are provided without overlapping in positions where diagonals of both the second and third color filters are aligned with each other in the plan view, and
the fourth color filter is provided in a region where the second and third color filters are not arranged within a square of which a diagonal in the plan view is a line segment defined by the aligned diagonals of both the second and third color filters, and is shaped in a rectangle in the plan view of which a length of a longer side is equal to that of the side of the second color filter in the plan view and a length of a shorter side is equal to that of the side of the third color filter in the plan view.

9. The solid-state image pickup device according to claim 8, further comprising:
a first micro lens shaped in a circle in the plan view of which a length of a diameter is equal to that of the side of the second color filter in the plan view, the first micro lens being provided over the light receiving surface of the second color filter in a position where the first micro lens is inscribed in an outer circumference of the second color filter in the plan view;
a second micro lens shaped in a circle in the plan view of which a length of a diameter is equal to that of the side of the third color filter in the plan view, the second micro lens being provided over the light receiving surface of the third color filter in a position where the second micro lens is inscribed in an outer circumference of the third color filter in the plan view; and
a third micro lens shaped in an ellipse in the plan view of which a length of a longer diameter is equal to that of the side of the second color filter in the plan view and a length of a shorter diameter is equal to that of the side of the third color filter in the plan view, the third micro lens being provided over the light receiving surface of the fourth color filter in position where the third micro lens is inscribed in an outer circumference of the fourth color filter in the plan view.

10. The solid-state image pickup device according to claim 9, wherein
the photoelectric conversion element provided with the second color filter is shaped in a quadrangle in the plan view that is inscribed in an outer circumference of the first micro lens in the plan view,
the photoelectric conversion element provided with the third color filter is shaped in a quadrangle in the plan view that is inscribed in an outer circumference of the second micro lens in the plan view, and
the photoelectric conversion element provided with the fourth color filter is shaped in a quadrangle in the plan view that is inscribed in an outer circumference of the third micro lens in the plan view.

11. The solid-state image pickup device according to claim 4, wherein
the second color filter is shaped in a square in a plan view,
the third color filter is shaped in a square in the plan view that has a side shorter than a side of the second color filter in the plan view,
the second and third color filters are provided without overlapping in positions where diagonals of both the second and third color filters are aligned with each other in the plan view, and
the fourth color filter is provided in a region where the second and third color filters are not arranged within a square of which a diagonal in the plan view is a line segment defined by the aligned diagonals of both the second and third color filters, and is shaped in a square in the plan view of which a length of a side is equal to that of the side of the third color filter in the plan view.

12. The solid-state image pickup device according to claim 11, wherein
a first micro lens shaped in a circle in the plan view of which a length of a diameter is equal to that of the side of the second color filter in the plan view, the first micro lens being provided over the light receiving surface of the second color filter in a position where the first micro lens is inscribed in an outer circumference of the second color filter in the plan view;
a second micro lens shaped in a circle in the plan view of which a length of a diameter is equal to that of the side of the third color filter in the plan view, the second micro lens being provided over the light receiving surface of the third color filter in a position where the second micro lens is inscribed in an outer circumference of the third color filter in the plan view; and
a third micro lens shaped in a circle in the plan view of which a length of a diameter is equal to that of the side of the fourth color filter in the plan view, the third micro lens being provided over the light receiving surface of the fourth color filter in a position where the third micro lens is inscribed in an outer circumference of the fourth color filter in the plan view.

13. The solid-state image pickup device according to claim 12, wherein
the photoelectric conversion element provided with the second color filter is shaped in a quadrangle in the plan view that is inscribed in an outer circumference of the first micro lens in the plan view,
the photoelectric conversion element provided with the third color filter is shaped in a quadrangle in the plan view that is inscribed in an outer circumference of the second micro lens in the plan view, and
the photoelectric conversion element provided with the fourth color filter is shaped in a quadrangle in the plan view that is inscribed in an outer circumference of the third micro lens in the plan view.

14. The solid-state image pickup device according to claim 8, wherein
the photoelectric conversion element provided with the third color filter is shaped in a quadrangle in the plan view that is inscribed in an outer circumference of the second micro lens in the plan view,
the photoelectric conversion element provided with the second color filter is of a same shape in the plan view as a shape of the photoelectric conversion element provided with the third color filter in the plan view, and has its center in the plan view laid in line with a center of the first micro lens in the plan view, and
the photoelectric conversion element provided with the fourth color filter is of the same shape in the plan view as the shape of the photoelectric conversion element provided with the third color filter in the plan view, and has its center in the plan view laid in line with a center of the third micro lens in the plan view.

15. The solid-state image pickup device according to claim 12, wherein
the photoelectric conversion element provided with the third color filter is shaped in a quadrangle in the plan view that is inscribed in an outer circumference of the second micro lens in the plan view,
the photoelectric conversion element provided with the fourth color filter is shaped in a quadrangle in the plan view that is inscribed in an outer circumference of the third micro lens in the plan view, and
the photoelectric conversion element provided with the second color filter is of a same shape in the plan view as a shape of the photoelectric conversion elements provided with the third and fourth color filters in the plan view, and has its center in the plan view laid in line with a center of the first micro lens in the plan view.

16. The solid-state image pickup device according to claim 8, further comprising:
a first micro lens shaped in a circle in the plan view of which a length of a diameter is equal to that of the side of the third color filter in the plan view, the first micro lens having its center laid in line with a center of the second color filter in the plan view;
a second micro lens having a same shape in the plan view as a shape of the first micro lens in the plan view, the second micro lens being provided over the light receiving surface of the third color filter in a position where the second micro lens is inscribed in an outer circumference of the third color filter in the plan view; and
a third micro lens having the same shape in the plan view as the shape of the first micro lens in the plan view, the third micro lens having its center in the plan view laid in line with a center of the fourth color filter in the plan view.

17. The solid-state image pickup device according to claim 16, wherein
the photoelectric conversion element provided with the second color filter in the plan view is smaller in area than the second color filter in the plan view and greater in area than the first micro lens in the plan view, and has its center in the plan view laid in line with the center of the second color filter in the plan view,
the photoelectric conversion element provided with the third color filter is shaped in a quadrangle in the plan view that is inscribed in an outer circumference of the second micro lens in the plan view, and
the photoelectric conversion element provided with the fourth color filter is shaped in a quadrangle in the plan view that is inscribed in an outer circumference of the third micro lens in the plan view.

18. The solid-state image pickup device according to claim 8, further comprising:
micro lenses provided over the light receiving surfaces of the second, third, and fourth color filters, respectively, the micro lenses being shaped in a circle in the plan view of which a length of a diameter is equal to that of the side of the third color filter in the plan view, and having their centers in the plan view laid in line with centers of the second, third, and fourth color filters in the plan view, respectively, wherein
the photoelectric conversion elements are shaped in quadrangles in the plan view that are inscribed in outer circumferences of the micro lenses in the plan view.

19. The solid-state image pickup device according to claim 4, wherein
the short-wavelength light is blue light,
the medium-wavelength light is green light, and
the long-wavelength light is red light.

20. The solid-state image pickup device according to claim 4, wherein
a color of the short-wavelength light is cyan,
a color of the medium-wavelength light is yellow, and
a color of the long-wavelength light is magenta.
